(19) United States
(12) Patent Application Publication
(10) Pub. No.: US 2025/0365495 A1
(43) Pub. Date: Nov. 27, 2025

(54) ULTRA WIDE BAND AUGMENTED IMAGING FOR IMPROVED ENTITY IDENTIFICATION

(71) Applicant: Microsoft Technology Licensing, LLC, Redmond, WA (US)

(72) Inventors: Charbel KHAWAND, Sammamish, WA (US); Andrew James HILLENIUS, Woodinville, WA (US)

(21) Appl. No.: 18/670,287

(22) Filed: May 21, 2024

(51) Int. Cl. H04N 23/61; G01S 13/76; H04N 23/695

(52) U.S. Cl. CPC H04N 23/61; G01S 13/765; H04N 23/695

(57) ABSTRACT

A camera system may determine positions of one or more candidate subjects in the camera view of at least one camera, wherein each candidate subject is associated with a positioning tag that stores an identity of the candidate subject. A camera system may receive identities of the one or more candidate subjects from the positioning tags. A camera system may match an identity of the tracked subject to an identity of a particular candidate subject of the one or more candidate subjects. A camera system may adjust camera operation of the at least one camera corresponding to a determined position of the positioning tag of the particular candidate subject relative to the at least one camera.

### BACKGROUND

Conventional entity detection processes for imaging involve detecting objects using contrast detection, pattern recognition, facial recognition, and other processes that look at image/video data to identify entities (e.g., objects or persons of interest) within the image/video. Such conventional entity detection processes are reliant on the camera/imaging system being able to detect an entity in a field of view.

### SUMMARY

In some aspects, the techniques described herein relate to a method for operating at least one camera based at least in part on a position of a tracked subject in a camera view of the at least one camera, the method including: determining positions of one or more candidate subjects in the camera view of the at least one camera, wherein each candidate subject is associated with a positioning tag that stores an identity of the candidate subject; and receiving identities of the one or more candidate subjects from the positioning tags; matching an identity of the tracked subject to an identity of a particular candidate subject of the one or more candidate subjects; and adjusting camera operation of the at least one camera corresponding to a determined position of the positioning tag of the particular candidate subject relative to the at least one camera.

In some aspects, the techniques described herein relate to a computing system for operating at least one camera based at least in part on a position of a tracked subject in a camera view of the at least one camera, the computing system including: one or more hardware processors; an identity and positioning processor executable by the one or more hardware processors and configured to: determine positions of one or more candidate subjects in the camera view of the at least one camera, wherein each candidate subject is associated with a positioning tag that stores the identity of the candidate subject; receive identities of the one or more candidate subjects from the positioning tags; and match an identity of the tracked subject to an identity of a particular candidate subject of the one or more candidate subjects; and a camera operation processor executable by the one or more hardware processors and configured to adjust camera operation of the at least one camera corresponding to a determined position of the positioning tag of the particular candidate subject relative to the at least one camera.

In some aspects, the techniques described herein relate to one or more tangible processor-readable storage media embodied with instructions for executing on one or more processors and circuits of a computing device a process for operating at least one camera based at least in part on a position of a tracked subject in a camera view of the at least one camera, the process including: determining positions of one or more candidate subjects in the camera view of the at least one camera, wherein each candidate subject is associated with a positioning tag that stores an identity of the candidate subject; and receiving identities of the one or more candidate subjects from the positioning tags; matching an identity of the tracked subject to an identity of a particular candidate subject of the one or more candidate subjects; and adjusting camera operation of the at least one camera corresponding to a determined position of the positioning tag of the particular candidate subject relative to the at least one camera.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example computing environment that includes a camera computing device that identifies entities in a field of view based at least in part on communicating with tags attached to the entities.

FIG. 2 illustrates an example computing environment that includes a camera computing device that determines a position associated with an entity by communicating with a tag attached to the entity.

FIG. 3 illustrates an example computing environment that includes a camera computing device that tracks a moving entity in a field of view based at least in part on communicating with a tag attached to the entity.

FIG. 4 illustrates an example computing environment that includes a camera computing device that tracks a moving entity in a field of view using a combination of communicating with a tag attached to the entity and image data analysis.

FIG. 5 illustrates example operations for adjusting a camera operation based at least in part on determining a position of a tracked subject within a camera view.

FIG. 6 illustrates an example computing device for use in implementing the described technology.

### DETAILED DESCRIPTIONS

Conventional entity detection processes for imaging that analyze image/video data to identify entities within an image/video are reliant on the camera/imaging system being able to detect an entity in a field of view from features of the image/video. However, in poor lighting conditions result in poor contrast detection and pattern recognition, and conventional image-data-based approaches to entity identification may fail to identify entities in image/video data. Also, in situations where lighting is adequate but in which features of an entity are not identifiable from the image/video data because of the positioning of the entity (e.g., a person of interest has his/her back to the camera), the conventional image-data-based approaches to entity identification may fail to identify entities in image/video data. Conventional entity detection approaches have also considered, in addition to the image/video data, light detection and ranging (LiDAR) data (e.g., reflected light) from the camera field of view to aid in entity detection. However, LiDAR data may not adequately track the movement of entities within the field of view and may not identify entities that are occluded by other entities within the field of view.

These failures to adequately identify entities in conventional approaches cause inferior performance of dependent processes such as camera autofocusing and auto framing. For example, in a video of a person singing, the imaging system may track the person's face and may autofocus and/or autoframe the camera on the face. In this example, if lighting conditions change during the recording of the video or if the person turns his/her head to the side such that the imaging system can no longer identify the face, the imaging system may autofocus and/or autoframe the camera on the wrong portion of its field of view until the lighting conditions improve or the repositioning of the face in the field of view enables the imaging system once again to identify the face.

The technology described addresses the deficiencies of conventional entity-identification approaches described above. The technology described herein involves attaching a tag to the entity to be identified/tracked in the imaging system's field of view. The imaging system communicates with the tag using a wireless communication protocol (e.g., ultra-wideband (UWB)), enabling the imaging system both to identify the entity from the identifier broadcast by the tag as well as to calculate a position (e.g., angle and distance) of the identified entity within the field of view (e.g., by using a time of flight (TOF) calculation). The imaging system of the technology described herein may communicate with the tag attached to the entity even when the entity is occluded by other objects in the imaging system's field of view. Accordingly, the technology described herein can effectively identify/track occluded entities within a field of view, unlike conventional image-data-based and LiDAR-based entity identification approaches which do not identify occluded entities. For example, the technology described herein improves the identification and tracking of entities within captured video/image data under poor lighting conditions. The technology described herein can effectively identify/track entities in image/video data captured under poor lighting conditions whereas conventional approaches (e.g., facial/feature recognition, pattern recognition, and other image/video data analysis approaches) may not be able to identify/track entities in video/image data captured under poor lighting conditions.

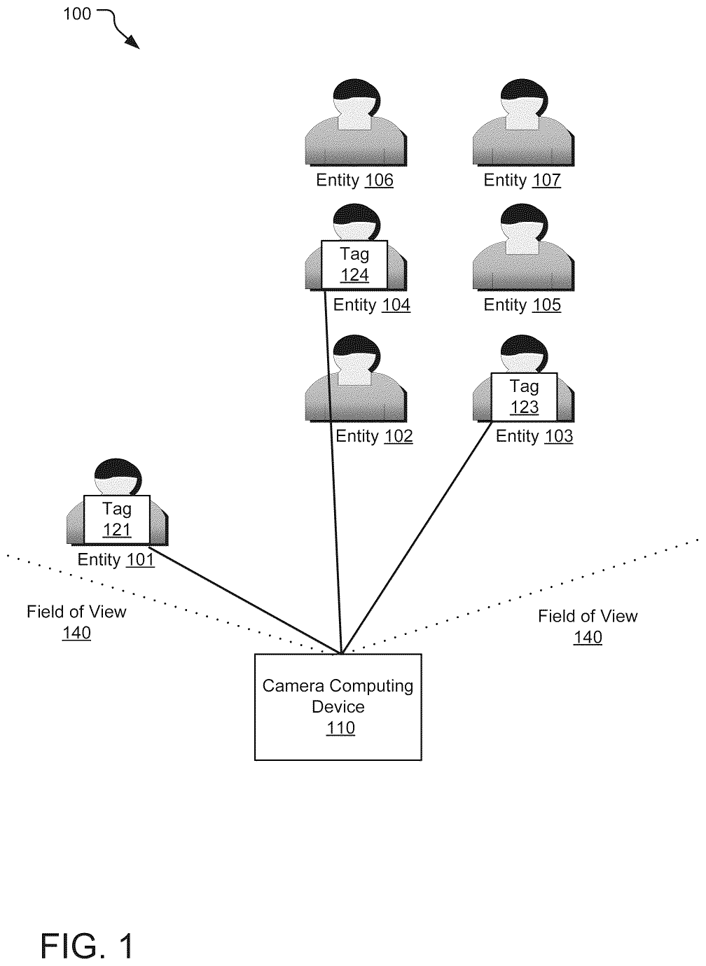

FIG. 1 illustrates an example computing environment 100 that includes a camera computing device 110 that identifies entities in a field of view based at least in part on communicating with tags attached to the entities. In the example depicted in FIG. 1, the camera computing device 110 captures an image or records a video within its field of view 140, depicted by dashed lines in the example in FIG. 1. Various entities (e.g., persons including entity 101, entity 102, entity 103, entity 104, entity 105, entity 106, entity 107) are located within the field of view of the camera computing device 110. The example entities (e.g., entity 101, entity 102, entity 103, entity 104, entity 105, entity 106, and entity 107) depicted in FIG. 1 are people, however, in some instances, the entities can include objects, animals, regions of interest, or other entities. As depicted in FIG. 1, three entities (e.g., entity 101, entity 102, entity 103) have tags (e.g., tag 121, tag 123, tag 124, respectively) attached. An example tag could be a badge, a mobile device, a microchip, a wearable device, or another device that can communicate with the camera computing device 110 via an ultra-wideband (UWB) communication protocol or other wireless communication protocol. In some instances, the tag is held or carried by the entity. For example, the tag (e.g., tag 121) is attached to a microphone of the entity (e.g., entity 101), or attached to a nametag/badge attached to the entity. In some instances, the tag is attached to an object (e.g., a chair, a podium) where the entity is expected to be located during the capture of the image/video.

In the example depicted in FIG. 1, the camera computing device 110 identifies three entities (e.g., entity 101, entity 102, and entity 103) within the field of view 140 by communicating with tags (e.g., tag 121, tag 123, and tag 124) attached to the three entities. The identification and location of the entity by the camera computing device 110 within the field of view 140 is represented in FIG. 1 using solid lines. For example, the solid line between the camera computing device 110 and entity 101 represents the identification of and locating of entity 101 by the camera computing device 110 within the field of view 140. For example, the solid line between the camera computing device 110 and entity 102 represents the identification of and locating of entity 102 by the camera computing device 110 within the field of view 140. For example, the solid line between the camera computing device 110 and entity 103 represents the identification of and locating of entity 103 by the camera computing device 110 within the field of view 140.

In some instances, the camera computing device 110 identifies the entity and its location by transmitting, using a UWB protocol or other identifying and locating technology, a request to a tag and receiving a response from the tag. For example, the camera computing device 110 broadcasts a request to any devices within a predefined UWB broadcasting range of the camera computing device 110, and each of tag 121, tag 123, and tag 124 receives the broadcasted request and then transmits a response that is received by the camera computing device 110. For example, the tag 121 attached to entity 101 broadcasts a response including an entity 101 identifier associated with tag 121, the tag 123 attached to entity 103 broadcasts a response including an entity 103 identifier associated with tag 123, and the tag 124 attached to entity 104 broadcasts a response including an entity 104 identifier associated with tag 124. The camera computing device 110 receives each of the responses broadcast by the tags (e.g., tag 121, tag 123, tag 124) via the UWB protocol. The camera computing device 110 identifies the respective entity associated with the entity identifier received in the response. The camera computing device 110 also identifies a position associated with the identified entity. In some instances, the position is defined by a distance and an angle of arrival. In some instances, to determine the distance, the camera computing device 110 determines a time of flight (TOF) based at least in part on the time elapsed between the first time when the camera computing device 110 transmitted the request and the second time when the camera computing device 110 received a response that included the entity 101 identifier. In some instances, the distance is calculated by dividing the TOF by two and then multiplying by the known signal speed (e.g., the signal speed may be assumed to be the speed of light). In some implementations, the tag determines a time of flight (and/or an angle of arrival) for the request when it receives the request from the camera and then transmits the time of flight calculation in its response to the camera computing device. These methods of determining a time of flight are examples and other methods may be used. In some instances, to determine an angle of arrival of a received response from the tag, the camera computing device 110 measures a phase difference of arrival (PDoA) of the received response at multiple receiver antennas of the camera computing device 110 and determines the angle of arrival from the PDoA. As depicted in FIG. 1, although entity 104 is occluded in the field of view 140 of the camera computing device 110 by entity 102, the camera computing device 110 is still able to identify and locate entity 104 (as indicated by the solid line extending from camera computing device 110 to the entity 104) because the occlusion of entity 104 by entity 102 does not prevent the camera computing device 110 from communicating with the tag 124.

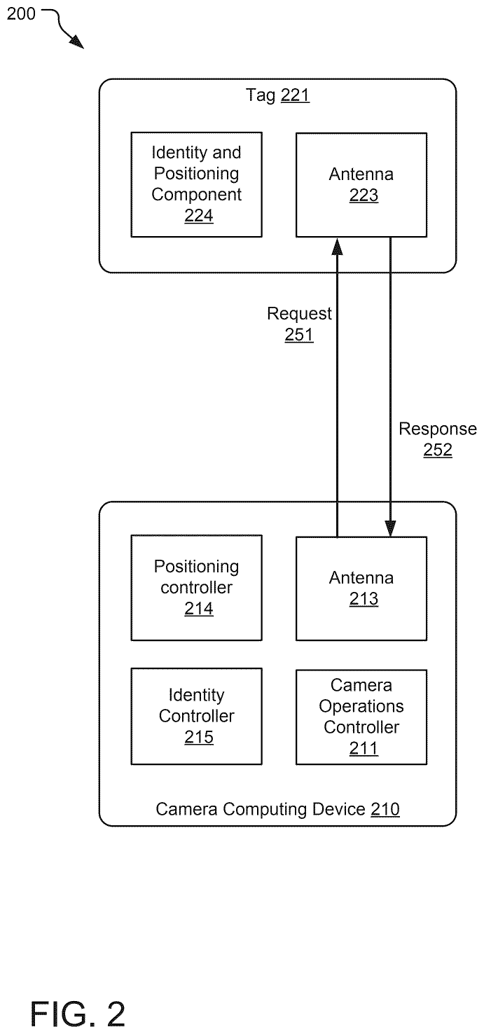

FIG. 2 illustrates an example computing environment 200 that includes a camera computing device 210 that determines a position associated an entity by communicating with a tag 221 attached to the entity. Within the computing environment 200, the general functionality of the camera computing device 210 and the tag 221 is the same or similar to that described with respect to like-named components of other figures herein.

The camera computing device 210 includes a camera operation controller 211, an antenna 213, a positioning controller 214, and an identity controller 215. The camera operation controller 211 may adjust one or more focus settings of the camera computing device 210. In some implementations, the camera operation controller 211 adjusts one or more focus settings of the camera computing device 210 (e.g., focus, zoom in and out, adjust an exposure setting, etc.) to focus on an entity at its determined location (e.g., location A) in the field of view of the camera computing device 210. The camera operation controller 211 can adjust one or more settings of the camera computing device 210 to focus or track the entity as it detects (by communicating with the tag 221) the entity moving from one determined location (e.g., location A) to another determined location (e.g., location B). In some instances, the camera operation controller 211 may move the camera including panning, tilting, arcing, booming, rolling, and/or otherwise perform auto framing operations and/or adjust the field of view, or adjusting other settings of the camera computing device 210 to track an entity at its determined location (e.g., location A) in the field of view of the camera computing device 210. The camera operation controller 211 may adjust the settings of the camera computing device 210 to track the entity as it detects (by communicating with the tag 221) the entity moving from one determined location (e.g., location A) to another determined location (e.g., location B).

The positioning controller 214 communicates with an antenna 213 to broadcast a request 251 (e.g., a poll) according to a UWB protocol. The request includes a camera computing device 210 identifier. The positioning controller 214 receives, via the antenna 213, response 252 signals broadcast by tag(s) (e.g., tag 221) that received the request 251. The positioning controller 214 determines the position of entities based at least in part on determining the position of corresponding tag(s) associated with the entities. For example, the positioning controller 214 determines, for each tag (e.g., tag 221) and responsive to receiving a response 252 from the tag, the entity associated with the tag, and a distance and an angle of arrival that defines a position of the entity relative to the camera computing device 210. In some instances, the position is defined in terms of one or more of the distance and angle of arrival calculated responsive to receiving the response 252 from the tag. For example, in some implementations, a one-dimensional distance may be used that is defined by the determined distance. In some implementations, a three-dimensional distance may be used that is defined by the determined distance and the determined angle of arrival.

In some implementations, the positioning controller 214 calibrates, normalizes, or otherwise adjusts a determined position of an entity in view of a location of one or more specific components of the camera (e.g., with respect to locations of specific hardware of the camera, for example, a sensor or a lens). In some implementations, the antenna 213 is not located at the same or substantially the same location as one or more components of the camera computing device 210 used for autofocusing and/or auto framing operations. For example, the positioning controller 214 adjusts the determined position of the entity so that autofocusing and/or auto framing operations that are performed based at least in part on the determined position can be performed accurately. In some implementations, the antenna 213 is located on a device that is communicatively coupled to the camera computing device 210, and a relative position (e.g., distance, and/or angle of arrival) of the entity is first determined in comparison to the position of the separate device and then adjusted with respect to locations of one or more components of the camera computing device 210. In some implementations, the camera computing device 210 performs a tuning process to determine an offset distance between the location of the antenna 213 with respect to a location of the camera computing device 210 and the relative position of the entity is adjusted based at least in part on the offset.

In some implementations, the antenna 213 is located on the camera computing device 210 in proximity to one or more specific components of the camera such that the position information for the entity may be precisely determined with regard to locations of the one or more specific components of the camera computing device 210. For example, the antenna 213 is located next to a specific component (e.g., a sensor, a lens) such that the distance of the entity is determined based at least in part on the time of flight of the response 252 and/or the angle of arrival determined based at least in part on the phase difference of the received response 252 across the antenna array of the antenna 213) is determined with respect to the location(s) of the one or more specific components. In some implementations, the determined angle of arrival is mapped to the camera view of the camera computing device 210 so that the positioning controller 214 may adjust, in accordance with one or more camera rules, the determined position of the entity so that autofocusing and/or auto framing operations can be performed accurately. For example, if a condition happens (e.g., if the determined distance indicates that the entity is moving out of frame), then the one or more camera rules may specify how the focus, framing, and/or tracking of the camera computing device 210 can be adjusted to keep the entity within the field of view. In another example, the one or more camera rules may specify how to focus on two or more entities simultaneously based at least in part on the determined distance and angle of the entities from the camera computing device 210. In some implementations, the camera rules determine which detected entities remain in the camera video feed (or image capture), which detected entities are removed from the camera video feed (or image capture), which detected entities have a priority of focus, and which detected entities are designated users for for gesture commands.

In some implementations, the identity controller 215 includes a machine learning model. The machine learning model receives input data including image/video data from the camera, identifiers received from one or more UWB tags (e.g., tag 221) associated with one or more entities, distance and/or angle of arrival determined by the positioning controller 214 for response transmissions (e.g., response 252) received from the one or more UWB tags and outputs positions for a set of entities for the image/video and an identity of each of entities in the set of entities. The machine learning model may supplement facial recognition techniques, boundary recognition techniques, or other image-data-based and/or video-data-based techniques to identity entities within image/video data with the identification of entities in image/video data using identifier/position information determined from UWB response transmissions.

The antenna 223, in some implementations, is an antenna array including a plurality (e.g., two or more) of antennas, and the identity and positioning controller 224 determines an angle of arrival based at least in part on the PDoA between the antennas of the antenna array of the received response 252. For example, each of the antennas of the antenna array is at a different position and receives the response 252 at a slightly different time as well as from a slightly different angle from each of the other antennas of the antenna array. The PDoA, in some implementations, represents the difference in individual angles of arrival of the response 252 as received at each of the antennas of the antenna array. In some implementations, the angle of arrival is determined as an average angle of arrival of the antennas of the antenna array.

In some implementations, the camera computing device 210 has the ability to focus on multiple entities in its field of view (e.g., multi focus capabilities). In some implementations, the computing environment 200 includes multiple camera computing devices, where all of the camera computing devices communicate with a proximity system to produce various images. In these implementations, an artificial intelligence (AI) system may mix, combine, or otherwise synthesize the images captured by the multiple camera computing devices or adjust the capture of the images to generate one or more synthesized images of the one or more entities. In some implementations, proximity and distance information could also help the speed of camera mechanical focus to handle fast adjust of its focal lens on both objects in consecutive shots (or in a video stream) and then have its ISP merge them into one. Being assisted with an accurate distance information of detected entities, as provided by the described technology, allows a camera to have faster captures than it would have with mechanical or digital auto focus.

The tag 221, in some implementations, is an ultra-wideband (UWB) tag. However, other communication protocols other than UWB may be used. The tag 221 includes an identity and positioning component 224 and an antenna 223. The identity and positioning component 224 communicates with an antenna 213 (e.g., in some implementations, an antenna array) to receive a request 251 broadcast by the camera computing device 210 and to broadcast a response 252 according to a UWB protocol. The response 252 includes an identifier associated with the tag 221.

In some implementations, the response 252 includes a tag identifier but not the entity identifier, and the tag 221 transmits, via a separate communication channel (e.g., via Wi-Fi, via Bluetooth, or other non-UWB communication channel) the tag identifier and an entity identifier identifying the entity. In these implementations, the camera computing device 210 determines the position of the entity based at least in part on the received response 252 (e.g., by determining distance and/or angle of arrival) and then associates an identity with the received position based at least in part on the entity identifier received via the other communication channel (e.g., via the Wi-Fi, Bluetooth, or other communication channel with the tag 221. In some implementations, the response 252 includes a tag identifier but not an entity identifier, and the camera computing device 210 determines the entity identity associated with the tag using other techniques. For example, the camera computing device 210 detects a gesture of the entity (e.g., blinking one eye, wearing an article of clothing of a particular color, etc.) that signals the identity of the entity, and the camera computing device 210 assigns an entity identifier associated with the detected gesture at a location within the video feed or image corresponding to a position determined for a tag 221 that is within a predefined proximity to a location within the video/image where the gesture was detected.

In some implementations, the camera computing device 210 may assign the candidate identities to be associated with positions determined for two or more tags via detecting the gesturing of one or more of the entities in the video/image data captured by the camera computing device 210. In these implementations, the camera computing device 210 may output a request (e.g., an audio or display) or may transmit a request to another device (e.g., a speaker or mobile device) to display or otherwise output a request for one of the two candidate entities to perform a gesture. For example, unidentified entity A and unidentified entity B associated with respective tags are each located in the camera computing device 210 field of view. For example, the camera computing device 210 determined the positions of tags for unidentified entities A and B based at least in part on UWB responses (e.g., response 252) received from each of the tags. The camera computing device 210 requests “Alex” to perform a gesture (e.g., blinking one eye). Responsive to detecting unidentified entity A performing the requested gesture in the captured image/video data, the camera computing device 210 assigns the identity “Alex” to unidentified entity A. For example, the camera computing device 210 assigns the tag identifier received from the tag associated with the previously unidentified entity A with the identity of “Alex.” The camera computing device 210 may request that “Bryan” perform the same gesture or a different gesture. Responsive to detecting unidentified entity B performing the requested gesture (or requested different gesture) in the captured image/video data, the camera computing device 210 assigns the identity “Bryan” to unidentified entity B. For example, the camera computing device 210 assigns the tag identifier received from the tag associated with the previously unidentified entity B with the identity of “Bryan.”

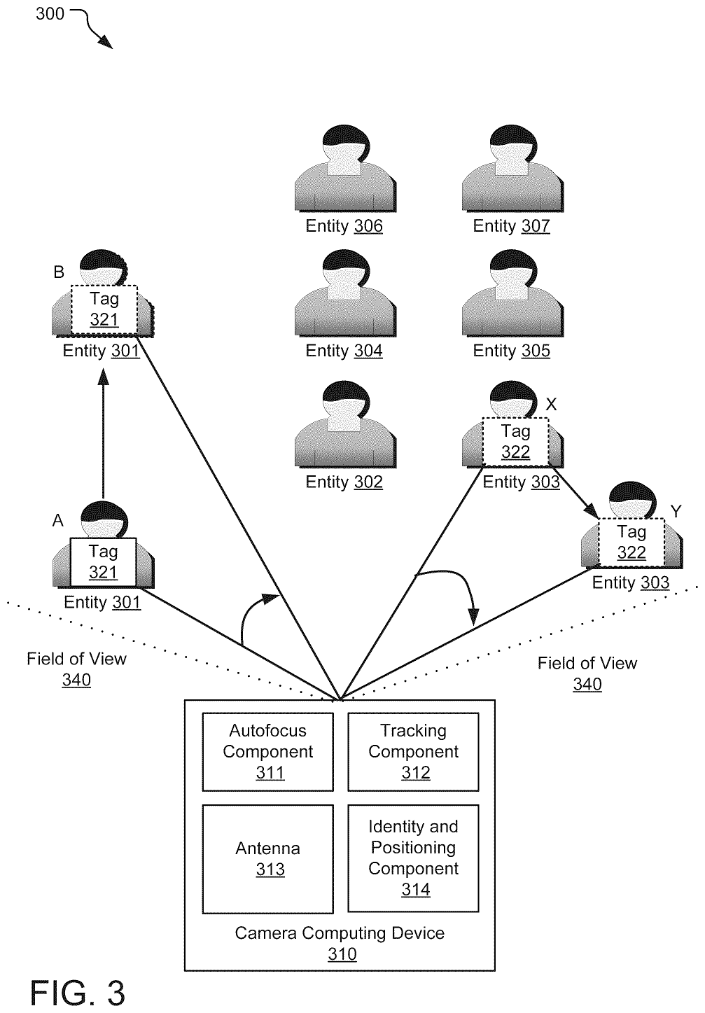

FIG. 3 illustrates an example computing environment 300 that includes a camera computing device 310 that tracks a moving entity in a field of view based at least in part on communicating with a tag attached to the entity. Within the computing environment 300, the general functionality of the camera computing device 310 and tag 321 is the same or similar to that described with respect to like-named components of other figures herein.

The example computing environment 300 includes a camera computing device 310 and multiple entities (e.g., entity 301, entity 302, entity 303, entity 304, entity 305, entity 306, and entity 307) within a field of view 340 of the camera computing device 310. For example, the camera computing device 310 may include an autofocus component 311, a tracking component 312, an antenna 313, and an identity and positioning component 314.

In the example depicted in FIG. 3, the camera computing device 310 captures an image or records a video within its field of view 340, depicted by dashed lines in the example in FIG. 3. As depicted in FIG. 3, entity 301 has a tag 321 attached to the entity 301 and entity 302 has a tag 322 attached to the entity 303. The camera computing device 310 communicates with the tag 321 while the entity 301 is located at position A and determines that entity 301 is at position A, as indicated by the solid line extending from the camera computing device 310 to the entity 301 at position A. Also, the camera computing device 310 communicates with tag 322 while the entity 303 is at position X, as indicated by the solid line extending from the camera computing device 310 to the entity 303 at position X. Determining position A can include communicating a request to the tag 321 and determining, based at least in part on and responsive to receiving a response from the tag 321, a distance and an angle of arrival. In some instances, position A is defined in terms of the distance and angle of arrival calculated responsive to receiving the response from the tag 321. Determining position X can include communicating a request to the tag 322 and determining, based at least in part on and responsive to receiving a response from the tag 322, a distance and an angle of arrival. In some instances, position X is defined in terms of the distance and angle of arrival calculated responsive to receiving the response from the tag 322. In some implementations, the initial positions (e.g., position A and position X) for multiple tags (e.g., tag 321 and tag 322) can be determined at the same time or substantially the same time.

As depicted in the example in FIG. 3, the entity 301 moves from location A (depicted as “A”) to location B (depicted as “B”), and the camera computing device 310 identifies the entity 301 and determines the location of the entity 301 at location B within the field of view 340 by communicating with the tag 321. The camera computing device 310 communicates with the tag 321 while the entity 301 is located at position B and determines that entity 301 is at position B, as indicated by the solid line extending from the camera computing device 310 to the entity 301 at position B within the field of view 340. Determining position B may include communicating a request to the tag 321 and determining, based at least in part on and responsive to receiving a response from the tag 321, a distance and an angle of arrival. In some instances, position B is defined in terms of the distance and angle of arrival calculated responsive to receiving the response from the tag 321. As shown in the FIG. 3, at position B, the face of the entity 301 is facing away from the camera computing device 310. The technology described herein enables the camera computing device 310 to identify and locate the entity 301 at position B without needing to rely on facial recognition, pattern/contrast recognition, or other image-based data.

As depicted in the example in FIG. 3, the entity 303 may move from location X (depicted as “X”) to location Y (depicted as “Y”), and the camera computing device 310 identifies the entity 303 and determines the location of the entity 303 at location Y within the field of view 340 by communicating with the tag 322. The camera computing device 310 communicates with the tag 322 while the entity 303 is located at position Y and determines that entity 303 is at position Y, as indicated by the solid line extending from the camera computing device 310 to the entity 303 at position Y within the field of view 340. Determining position Y may include communicating a request to the tag 322 and determining, based at least in part on and responsive to receiving a response from the tag 322, a distance and an angle of arrival. In some instances, position Y is defined in terms of the distance and angle of arrival calculated responsive to receiving the response from the tag 322. In some implementations, the subsequent positions (e.g., position B and position Y) for multiple tags (e.g., tag 321 and tag 322) can be determined at the same time or substantially the same time.

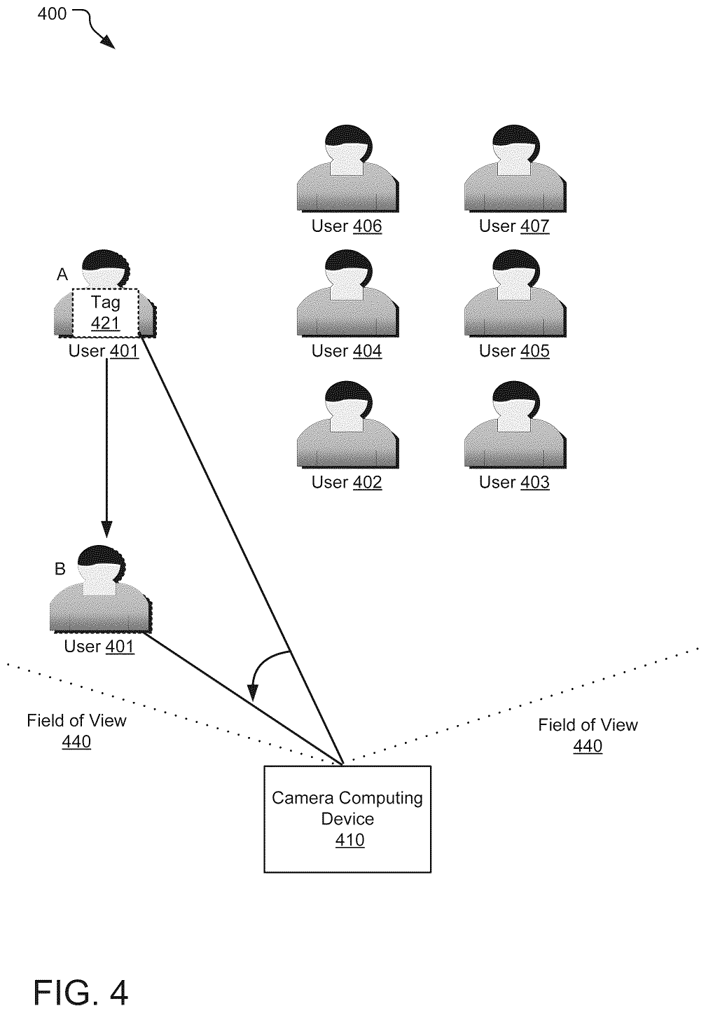

FIG. 4 illustrates an example computing environment 400 that includes a camera computing device 410 that tracks a moving entity in a field of view using a combination of communicating with a tag attached to the entity and image data analysis. Within the computing environment 400, the general functionality of the camera computing device 410 and tag 421 is the same or similar to that described with respect to like-named components of other figures herein.

The example computing environment 400 includes a camera computing device 410 and multiple entities (e.g., entity 401, entity 402, entity 403, entity 404, entity 405, entity 406, and entity 407) within a field of view 440 of the camera computing device 410. As depicted in FIG. 4, entity 401 has a tag 421 attached to the entity 401. The camera computing device 410 communicates with the tag 421 while the entity 401 is located at position A and determines that entity 401 is at position A, as indicated by the solid line extending from the camera computing device 410 to the entity 401 at position A. Determining position A can include communicating a request to the tag 421 and determining, based at least in part on and responsive to receiving a response from the tag 421, a distance and an angle of arrival. In some instances, position A is defined in terms of the distance and angle of arrival calculated responsive to receiving the response from the tag 421.

As depicted in the example in FIG. 4, the entity 401 moves from location A (depicted as “A”) to location B (depicted as “B”). However, the entity 401 leaves the tag at location A before moving to location B. For example, the tag 421 is or is on an object held by the user. For instance, the tag 421 may be a mobile device or may be attached to a badge that the entity 401 leaves at location A before proceeding to move to location B. In another instance, the tag 421 is integrated into a fixed object such as a podium at location A and the entity 401 (e.g., a speaker giving a presentation) leaves the podium to walk toward position B. The camera computing device 410 identifies the entity 401 and determines the location of the entity 401 at location B within the field of view 440 by analyzing image/video data recorded or otherwise captured by the camera computing device 410 and not by communicating with the tag 421. The camera computing device 410 identifies the entity 401 at location B based at least in part on feature recognition (e.g., facial recognition), pattern recognition, contrast recognition, or other image-based technique (e.g., identifying the entity and locating the entity based at least in part on image data), as indicated by the solid line extending from the camera computing device 410 to the entity 401 at position B within the field of view 440. In some instances, the camera computing device 410 determines position B using image data captured by the camera computing device 410.

In some implementations, identifying the entity 401 at location A and/or location B includes applying a machine learning model to input data including image/video data from the camera, identifiers received from one or more UWB tags (e.g., tag 221) associated with one or more entities, distance and/or angle of arrival determined by response transmissions (e.g., response 252) received from the one or more UWB tags and outputs positions for a set of entities for the image/video and an identity of each of entities in the set of entities. The machine learning model may supplement facial recognition techniques, boundary recognition techniques, or other image-data-based and/or video-data-based techniques to identity entities within image/video data with the identification of entities in image/video data using identifier/position information determined from UWB response transmissions. In some instances, the machine learning model is trained with a set of video data involving scenarios in which entities located using UWB response transmissions become separate from their associated tags (e.g., the entity removes a tag including the badge, the entity leaves a mobile device that is acting as a UWB tag, etc.) and move to a subsequent location. For example, the machine learning model may be trained to recognize the tag (e.g., recognize the tag itself or a device or document that includes the tag) and therefore recognize when the tag is separated from the entity. The machine learning model may disregard UWB-based identification/positioning determinations when the tag is determined to be separated from the entity and rely solely on image-based and/or video-based approaches (e.g., feature/facial identification, pattern recognition, etc.) In some instances, an AI system can remove or otherwise edit unwanted objects that are not tagged (e.g., entities detected within the camera field of view for which tags are not detected). For example, the AI system may fill their position artificially using the surroundings of the unwanted object. For example, the unwanted objects are removed from the image and the regions of the image from which the unwanted objects are removed are edited to resemble a background of the image. In some implementations, the AI system removes an entity within the field of view for which a tag has been detected and all untagged objects (or a mix of tagged and untagged objects) remain in that image and are not removed or otherwise edited by the AI system.

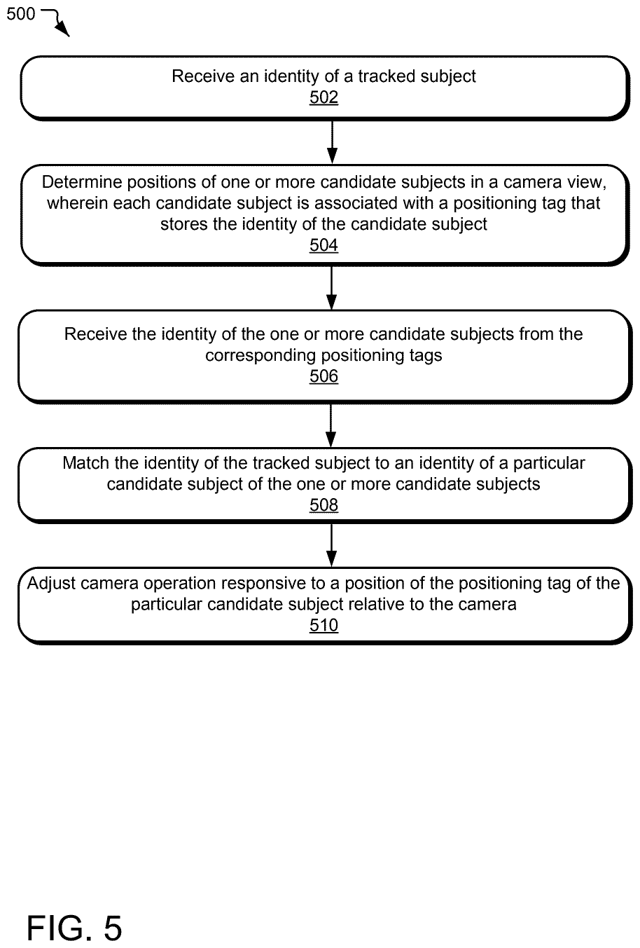

FIG. 5 illustrates example operations 500 for adjusting a camera operation based at least in part on determining a position of a tracked subject within a camera view. The example operations 500 include example operation 502, example operation 504, example operation 506, example operation 508, and example operation 510. In some implementations, the example operations 500 are performed by a camera computing device. In some implementations, the example operations 500 are performed by an image processing system or a video processing system that comprises a camera computing device or that is otherwise communicatively coupled to a camera computing device.

Example operation 502 involves an operation to receive an identity of a tracked subject. In some implementations, the operation 502 involves receiving the identity input at a user interface. For example, a user requests to locate or track a tracked subject in a video feed or an image captured by a camera computing device. In some instances, the operation 502 involves retrieving (e.g., from a storage device or other memory) an identifier associated with the received identity of the tracked subject. In one example, the tracked subject is an employee who works at a secure location, the identity is the employee's name, and the identifier is an employee identifier (e.g., an identifier comprising alphanumerical, symbolic, and/or other characters) assigned to the employee.

Example operation 504 involves an operation to determine positions of one or more candidate subjects in a camera view, wherein each candidate subject is associated with a positioning tag that stores the identity of the candidate subject. In some implementations, operation 504 involves receiving via an antenna, response signals broadcast by tag(s) (e.g., UWB tags) within a predefined distance that received a request broadcast by an Identity and positioning component of the camera computing device. The predefined distance is a communication range over which request and response communications can be transmitted via the UWB protocol. The example operation 504 involves determining the position of entities based at least in part on determining the position of corresponding tag(s) associated with the entities. For example, the example operation 504 involves determining, for each tag and responsive to receiving a response from the tag, a distance (e.g., in some implementations, calculated from the time of flight of one or more of the request or the response) and an angle of arrival (e.g., in some implementations determined via a phase difference of the received response for an antenna array) that defines a location of the entity associated with the tag. In some instances, the position is defined in terms of the distance and angle of arrival calculated responsive to receiving the response from the tag.

Example operation 506 involves an operation to receive identifiers of the one or more candidate subjects from the corresponding positioning tags. For example, the response received from each of the positioning tags includes an identifier that identifies a respective candidate subject. For example, the candidate subjects may be employees that work at a secure location, each of the employees having a respective tag that transmits a respective identifier that identifies the employee.

Example operation 508 involves an operation to match the identity of the tracked subject to an identity of a particular candidate subject of the one or more candidate subjects. For example, the operation 508 involves determining that one of the received identifiers matches the identifier associated with the tracked subject. The example operation 508 involves comparing the identifier associated with the tracked subject to each identifier received from the one or more tags to determine a matching identifier. In some instances, the example operation 508 involves matching the identities of a plurality of tracked subjects to identities of a plurality of candidate subjects of the one or more candidate subjects.

Example operation 510 involves an operation to adjust a camera operation responsive to a position of the positioning tag of the particular candidate subject relative to the camera computing device. For example, the example operation 508 found an identifier of a particular candidate subject that matches the identifier associated with the tracked subject and retrieves the most recent position determined based at least in part on distance and angle of arrival information calculated from the response received from the tag that transmitted the identifier (e.g., as determined in example operation 506). Adjusting the camera operation can include adjusting one or more focus settings of the camera computing device (e.g., using an autofocus component of a camera computing device) or moving the camera computing device including panning, tilting, arcing, booming, rolling, and/or otherwise adjusting the field of view, or adjusting other settings of the camera computing device to track an entity at its determined location in the field of view. In some instances, the example operation 510 involves adjusting the camera operation responsive to the positions of a plurality of positioning tags of a plurality of particular candidate subjects relative to the camera computing device. For example, the example operation 510 can involve performing autofocus operations to focus on two identified entities within the image/video. Adjusting the camera operation can include, in some implementations, capturing one or more images, turning off the camera, pausing the camera, changing one or more camera filters (e.g., from color to black and white, etc.), activating or deactivating a flash, adjusting an exposure, and/or other camera operations.

In some implementations, in addition to or instead of adjusting a camera operation, the operation 510 can involve applying one or more techniques to alter the captured image/video data based at least in part on the identified entity positions. For example, the operation 510 can involve removing the entity from the image/video data and replacing the region of the image/video with the background or with an approximation of the background. For example, the operation 510 can involve replacing the entity from the image/video data with another entity. For example, the operation 510 may involve determining (e.g., from status information in a table or other database) that the entity must be obscured or otherwise obfuscated in the video/image. For example, obscuring or obfuscating the entity may involve blurring, in the video/image, the entity's face or replacing the entity's face with an avatar to protect the entity's privacy.

In some implementations, the example operation 510 for adjusting camera operation involves providing a level of control to an entity that is identified via gesturing. For example, a position for an entity is identified based at least in part on a position calculated for a UWB tag, and the entity in proximity to the UWB tag is identified via a gesture (e.g., performing a movement, wearing a particular color, etc.) that is captured in the video/image data of the camera computing device. Responsive to identifying the entity via the gesture at the determined position, providing the level of control can include monitoring the entity for further gestures that are interpreted as commands to perform camera operations. For example, the entity identified via gesturing can instruct (e.g., via closing one eye, scratching their head, or other predefined gesture) the camera computing device to perform one or more operations (e.g., capture an image, pause the recording, etc.) and the example operation 510 may involve performing the one or more operations responsive to detecting the gesture of the entity captured in the video/image data. In some implementations, the example operation 510 for adjusting camera operation involves the camera computing device exiting a power saving mode (e.g., waking from a sleep mode) based at least in part on the position and identity of entities meeting a certain programmed condition (presence, distance, angle, etc.).

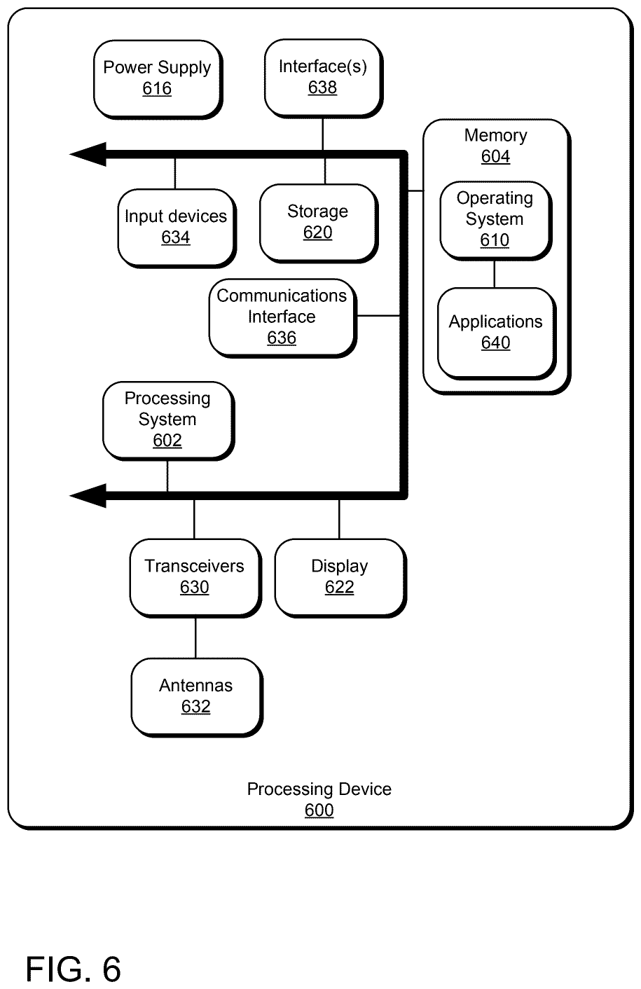

FIG. 6 illustrates an example computing device 600 for use in implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more hardware processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more software modules, segments, and/or processors, such as applications 640, an autofocus component, a tracking component, a camera operation component, an identity and positioning component, and other program code and modules are loaded into the operating system 610 on the memory 604 and/or the storage 620 and executed by the processor(s) 602. The storage 620 may store identifiers associated with one or more entities, position information for positions of entities determined within a camera field of view, and other data and be local to the computing device 600 or may be remote and communicatively connected to the computing device 600. In particular, in one implementation, components of a system for classifying a dataset may be implemented entirely in hardware or in a combination of hardware circuitry and software.

The computing device 600 includes a power supply 616, which may include or be connected to one or more batteries or other power sources, and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.
Clause 1. A method for operating at least one camera based at least in part on a position of a tracked subject in a camera view of the at least one camera, the method comprising: determining positions of one or more candidate subjects in the camera view of the at least one camera, wherein each candidate subject is associated with a positioning tag that stores an identity of the candidate subject; and receiving identities of the one or more candidate subjects from the positioning tags; matching an identity of the tracked subject to an identity of a particular candidate subject of the one or more candidate subjects; and adjusting camera operation of the at least one camera corresponding to a determined position of the positioning tag of the particular candidate subject relative to the at least one camera.
Clause 2. The method of clause 1, wherein determining positions of the one or more candidate subjects comprises determining the positions based at least in part on a response received from the positioning tags associated with the one or more candidate subjects.
Clause 3. The method of clause 2, wherein determining the positions comprises: determining, for each positioning tag, an angle of arrival of the response; and determining the position based at least in part on the angle of arrival.
Clause 4. The method of clause 3, wherein the response is received via an antenna array and wherein determining the angle of arrival comprises measuring a phase difference across antennas of the antenna array of the received response and calculating the angle of arrival from the measured phase difference.
Clause 5. The method of clause 2, wherein determining the positions comprises: broadcasting a request at a first time; receiving, from each positioning tag at a respective second time, a response from that includes a respective identity of the received identities; determining, for each positioning tag, a time of flight between the first time and the respective second time; calculating, for each positioning tag, a distance based at least in part on the time of flight; and determining, for each positioning tag, the position based at least in part on the distance.
Clause 6. The method of clause 5, wherein broadcasting the request includes broadcasting the request via ultra-wideband (UWB) communication channels and wherein receiving the identities includes receiving the identities via the UWB communication channels.
Clause 7. The method of clause 5, wherein broadcasting the request includes broadcasting the request via ultra-wideband (UWB) communication channels and wherein receiving the identities includes receiving the identities via Wi-Fi communication channels or Bluetooth communication channels.
Clause 8. The method of clause 1, wherein adjusting the camera operation comprises adjusting a focus of the at least one camera or modifying a field of view of the at least one camera.
Clause 9. The method of clause 1, wherein determining the position further comprises adjusting the position so that the position with respect to one or more specific components of the at least one camera.
Clause 10. A computing system for operating at least one camera based at least in part on a position of a tracked subject in a camera view of the at least one camera, the computing system comprising: one or more hardware processors; a positioning controller executable by the one or more hardware processors and configured to determine positions of one or more candidate subjects in the camera view of the at least one camera, wherein each candidate subject is associated with a positioning tag that stores the identity of the candidate subject; an identity controller executable by the one or more hardware processors and configured to receive identities of the one or more candidate subjects from the positioning tags; a matching controller executable by the one or more hardware processors and configured to match the identity of the tracked subject to an identity of a particular candidate subject of the one or more candidate subjects; and a camera operation controller executable by the one or more hardware processors and configured to adjust camera operation of the at least one camera corresponding to a determined position of the positioning tag of the particular candidate subject relative to the at least one camera.
Clause 11. The system of clause 10, the positioning controller further configured to determine the positions based at least in part on a response received from the positioning tags associated with the one or more candidate subjects.
Clause 12. The system of clause 11, wherein determining the positions comprises: determining, for each positioning tag, an angle of arrival of a response signal; and determining the position based at least in part on the angle of arrival.
Clause 13. The system of clause 12, wherein the response signal is received via an antenna array and wherein determining the angle of arrival comprises measuring a phase difference across antennas of the antenna array of the received response signal and calculating the angle of arrival from the measured phase difference.
Clause 14. The system of clause 11, wherein determining the positions comprises: broadcasting a request at a first time; receiving, from each positioning tag at a respective second time, a response signal from that includes a respective identifier; determining, for each positioning tag, a time of flight between the first time and the respective second time; calculating, for each positioning tag, a distance based at least in part on the time of flight; and determining, for each positioning tag, the position based at least in part on the distance.
Clause 15. One or more tangible processor-readable storage media embodied with instructions for executing on one or more processors and circuits of a computing device a process for operating at least one camera based at least in part on a position of a tracked subject in a camera view of the at least one camera, the process comprising: determining positions of one or more candidate subjects in the camera view of the at least one camera, wherein each candidate subject is associated with a positioning tag that stores an identity of the candidate subject; and receiving identities of the one or more candidate subjects from the positioning tags; matching an identity of the tracked subject to an identity of a particular candidate subject of the one or more candidate subjects; and adjusting camera operation of the at least one camera corresponding to a determined position of the positioning tag of the particular candidate subject relative to the at least one camera.
Clause 16. The one or more tangible processor-readable storage media of clause 15, wherein determining positions of the one or more candidate subjects comprises determining the positions based at least in part on a response received from the positioning tags associated with the one or more candidate subjects.
Clause 17. The one or more tangible processor-readable storage media of clause 15, wherein determining the positions comprises: determining, for each positioning tag, an angle of arrival of a response signal; and determining the position based at least in part on the angle of arrival.
Clause 18. The one or more tangible processor-readable storage media of clause 15, wherein receiving the identities includes receiving the identities via ultra-wideband (UWB) communication channels.
Clause 19. The one or more tangible processor-readable storage media of clause 15, wherein adjusting the camera operation comprises adjusting a focus of the at least one camera or modifying a field of view of the at least one camera.
Clause 20. The one or more tangible processor-readable storage media of clause 15, wherein determining the position further comprises adjusting the position so that the position with respect to one or more specific components of the at least one camera.
Clause 21. A system for operating at least one camera based at least in part on a position of a tracked subject in a camera view of the at least one camera, the system comprising: means for determining positions of one or more candidate subjects in the camera view of the at least one camera, wherein each candidate subject is associated with a positioning tag that stores the identity of the candidate subject; means for receiving identities of the one or more candidate subjects from the positioning tags; means for matching the identity of the tracked subject to an identity of a particular candidate subject of the one or more candidate subjects; and means for adjusting camera operation of the at least one camera corresponding to a determined position of the positioning tag of the particular candidate subject relative to the at least one camera.
Clause 22. The system of clause 21, the means for determining positions of the one or more candidate subjects further configured to determine the positions based at least in part on a response received from the positioning tags associated with the one or more candidate subjects.
Clause 23. The system of clause 22, wherein determining the positions comprises: determining, for each positioning tag, an angle of arrival of a response signal; and determining the position based at least in part on the angle of arrival.
Clause 23. The system of clause 23, wherein the response signal is received via an antenna array and wherein determining the angle of arrival comprises measuring a phase difference across antennas of the antenna array of the received response signal and calculating the angle of arrival from the measured phase difference.
Clause 24. The system of clause 21, wherein determining the positions comprises: broadcasting a request at a first time; receiving, from each positioning tag at a respective second time, a response signal from that includes a respective identifier; determining, for each positioning tag, a time of flight between the first time and the respective second time; calculating, for each positioning tag, a distance based at least in part on the time of flight; and determining, for each positioning tag, the position based at least in part on the distance.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method for operating at least one camera based at least in part on a position of a tracked subject in a camera view of the at least one camera, the method comprising:
determining positions of one or more candidate subjects in the camera view of the at least one camera, wherein each candidate subject is associated with a positioning tag that stores an identity of the candidate subject; and
receiving identities of the one or more candidate subjects from the positioning tags;
matching an identity of the tracked subject to an identity of a particular candidate subject of the one or more candidate subjects; and
adjusting camera operation of the at least one camera corresponding to a determined position of the positioning tag of the particular candidate subject relative to the at least one camera.

2. The method of claim 1, wherein determining positions of the one or more candidate subjects comprises determining the positions based at least in part on a response received from the positioning tags associated with the one or more candidate subjects.

3. The method of claim 2, wherein determining the positions comprises:
determining, for each positioning tag, an angle of arrival of the response; and
determining the position based at least in part on the angle of arrival.

4. The method of claim 3, wherein the response is received via an antenna array and wherein determining the angle of arrival comprises measuring a phase difference across antennas of the antenna array of the received response and calculating the angle of arrival from the measured phase difference.

5. The method of claim 2, wherein determining the positions comprises:
broadcasting a request at a first time;
receiving, from each positioning tag at a respective second time, a response from that includes a respective identity of the received identities;
determining, for each positioning tag, a time of flight between the first time and the respective second time;
calculating, for each positioning tag, a distance based at least in part on the time of flight; and
determining, for each positioning tag, the position based at least in part on the distance.

6. The method of claim 5, wherein broadcasting the request includes broadcasting the request via ultra-wideband (UWB) communication channels and wherein receiving the identities includes receiving the identities via the UWB communication channels.

7. The method of claim 5, wherein broadcasting the request includes broadcasting the request via ultra-wideband (UWB) communication channels and wherein receiving the identities includes receiving the identities via Wi-Fi communication channels or Bluetooth communication channels.

8. The method of claim 1, wherein adjusting the camera operation comprises adjusting, based at least in part on one or more camera rules, a focus of the at least one camera or modifying a field of view of the at least one camera.

9. The method of claim 1, wherein determining the position further comprises adjusting the position so that the position with respect to one or more specific components of the at least one camera.

10. A computing system for operating at least one camera based at least in part on a position of a tracked subject in a camera view of the at least one camera, the computing system comprising:
one or more hardware processors;
a positioning controller executable by the one or more hardware processors and configured to determine positions of one or more candidate subjects in the camera view of the at least one camera, wherein each candidate subject is associated with a positioning tag that stores the identity of the candidate subject;
an identity controller executable by the one or more hardware processors and configured to receive identities of the one or more candidate subjects from the positioning tags;
a matching controller executable by the one or more hardware processors and configured to match the identity of the tracked subject to an identity of a particular candidate subject of the one or more candidate subjects; and
a camera operation controller executable by the one or more hardware processors and configured to adjust camera operation of the at least one camera corresponding to a determined position of the positioning tag of the particular candidate subject relative to the at least one camera.

11. The system of claim 10, the positioning controller further configured to determine the positions based at least in part on a response received from the positioning tags associated with the one or more candidate subjects.

12. The system of claim 11, wherein determining the positions comprises:
determining, for each positioning tag, an angle of arrival of a response signal; and
determining the position based at least in part on the angle of arrival.

13. The system of claim 12, wherein the response signal is received via an antenna array and wherein determining the angle of arrival comprises measuring a phase difference across antennas of the antenna array of the received response signal and calculating the angle of arrival from the measured phase difference.

14. The system of claim 11, wherein determining the positions comprises:
broadcasting a request at a first time;
receiving, from each positioning tag at a respective second time, a response signal from that includes a respective identifier;
determining, for each positioning tag, a time of flight between the first time and the respective second time;
calculating, for each positioning tag, a distance based at least in part on the time of flight; and
determining, for each positioning tag, the position based at least in part on the distance.

15. One or more tangible processor-readable storage media embodied with instructions for executing on one or more processors and circuits of a computing device a process for operating at least one camera based at least in part on a position of a tracked subject in a camera view of the at least one camera, the process comprising:
determining positions of one or more candidate subjects in the camera view of the at least one camera, wherein each candidate subject is associated with a positioning tag that stores an identity of the candidate subject; and
receiving identities of the one or more candidate subjects from the positioning tags;
matching an identity of the tracked subject to an identity of a particular candidate subject of the one or more candidate subjects; and
adjusting camera operation of the at least one camera corresponding to a determined position of the positioning tag of the particular candidate subject relative to the at least one camera.

16. The one or more tangible processor-readable storage media of claim 15, wherein determining positions of the one or more candidate subjects comprises determining the positions based at least in part on a response received from the positioning tags associated with the one or more candidate subjects.

17. The one or more tangible processor-readable storage media of claim 15, wherein determining the positions comprises:
determining, for each positioning tag, an angle of arrival of a response signal; and
determining the position based at least in part on the angle of arrival.

18. The one or more tangible processor-readable storage media of claim 15, wherein receiving the identities includes receiving the identities via ultra-wideband (UWB) communication channels.

19. The one or more tangible processor-readable storage media of claim 15, wherein adjusting the camera operation comprises adjusting a focus of the at least one camera or modifying a field of view of the at least one camera.

20. The one or more tangible processor-readable storage media of claim 15, wherein determining the position further comprises adjusting the position so that the position with respect to one or more specific components of the at least one camera.
